(19) United States
(12) Patent Application Publication
(10) Pub. No.: US 2013/0191745 A1
(43) Pub. Date: Jul. 25, 2013

(54) INTERFACE FOR DISPLAYING SUPPLEMENTAL DYNAMIC TIMELINE CONTENT

(71) Applicants: Zane Vella, San Francisco, CA (US); Ole Lutjens, San Francisco, CA (US); John Fox, San Francisco, CA (US); Andrew Panfell, San Francisco, CA (US); Edward Lee Elliott, San Francisco, CA (US); Geoff Katz, San Francisco, CA (US); Herve Utheza, San Francisco, CA (US)

(72) Inventors: Zane Vella, San Francisco, CA (US); Ole Lutjens, San Francisco, CA (US); John Fox, San Francisco, CA (US); Andrew Panfell, San Francisco, CA (US); Edward Lee Elliott, San Francisco, CA (US); Geoff Katz, San Francisco, CA (US); Herve Utheza, San Francisco, CA (US)

(21) Appl. No.: 13/738,551

(22) Filed: Jan. 10, 2013

Related U.S. Application Data
(60) Provisional application No. 61/631,814, filed on Jan. 10, 2012.

(51) Int. Cl. G06F 3/01

(52) U.S. Cl. CPC G06F 3/01
USPC 715/716

(57) ABSTRACT

An interface for displaying supplemental dynamic timeline content, such as in connection with the playback of a movie title or content work is described.

This application claims benefit of priority to Provisional U.S. Patent Application 61/631,814, filed Jan. 10, 2012; the aforementioned priority application being hereby incorporated by reference in its entirety.

### TECHNICAL FIELD

Embodiments described herein pertain generally to an interface for displaying supplemental dynamic timeline content, such as in connection with the playback of a movie title or content work.

### BRIEF DESCRIPTION OF THE DRAWINGS

FIG. 1 illustrates a method of displaying dynamic timeline content, according to an embodiment.

FIG. 2 illustrates an interface that includes supplemental dynamic timeline content, in accordance with an embodiment.

FIG. 3 illustrates an example of an interface that includes supplemental dynamic timeline content, according to an embodiment.

FIG. 4A-4C illustrates interfaces for displaying dynamic timeline content, according to one or more embodiments.

FIG. 5 illustrates an alternative interface for displaying timeline content, according to an alternative embodiment.

FIG. 6 is a block diagram that illustrates a computer system upon which embodiments described herein may be implemented.

### DETAILED DESCRIPTION

Provisional U.S. Patent Application No. 61/497,023 (which is hereby incorporated by reference in its entirety) describes a time metadata service in which metadata is rendered in connection with the playback of a movie title or content work (e.g., television program). Services such as described in U.S. Patent Application No. 61/497,023 enable various forms of metadata content to be rendered in connection with the playback of a movie title or content work. Embodiments described herein further detail user-interface features, content and functionality in connection with the rendering of time-based metadata for movie titles and other content works.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

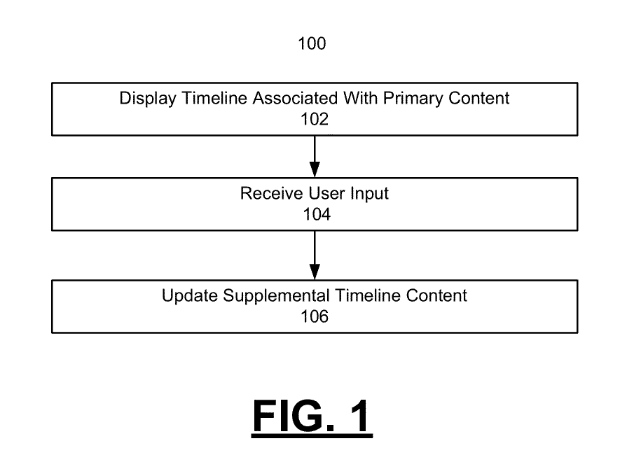

FIG. 1 illustrates a method of updating a displayed media timeline in an embodiment of the invention. A method such as described by an embodiment of FIG. 1 may be implemented by, for example, a system such as described with one or more embodiments of U.S. Patent Application No. 61/497,023. In such an embodiment, a metadata file may provide time-based metadata information associated with a media file. According to embodiments, the metadata includes information and content that is displayed to the user, but is not part of the content itself. Rather, such metadata is delivered to user watching the movie or program as an additional or independent layer. In some embodiments, the metadata is provided as part of an interface, separately from the primary display on which the content is rendered. For example, the metadata can be provided on a second screen (e.g., tablet).

A media file may include the timeline information, such as by using metadata. The metadata may include information which highlights the presence of objects that appear in the content of the associated media file, particularly as to commercial products, location of where the action of the content is occurring, or products seen in the scene represented in the content, or audio soundtrack (music) associated with the content. In an embodiment such metadata may be automatically generated, such as using programmatic resources. In another embodiment image analysis may be used to identify persons or objects in the content.

Alternatively, the timeline information may be stored or delivered through a third party. In such an embodiment the third party may provide information that highlights portions of the media content of interest, such as physical items.

Each of the embodiments described with respect to the Figures herein, including components and programmatic processes described with each embodiment, may be used individually or in combination with one another. In particular, embodiments described herein enable the rendering of content, such as movies and/or television programs, to be enhanced with the display of relevant metadata information that pertains to events that are part of the content being watched. For example, the appearance of an actor in the movie or program may be supplemented with relevant metadata information that includes the name of the actor who is playing the character, as well as additional information about the actor or character. Likewise, (i) the presence of objects that appear in the content may be highlighted by metadata, particularly as to commercial products; (ii) the use of locations in the content may also be supplemented with information about such location; or (iii) music and/or a soundtrack playing in the audio background or as the primary audio track may be supplemented with metadata. Numerous other examples are provided herein for enhancing or supplementing the presentation of content, such as provided by movies and programs, with metadata information regarding the events that occur as part of the content being watched.

In Step 102 of method 100 of FIG. 1, a timeline associated with a primary content is displayed on a user interface. The timeline may be in the form of a graphic that correlates timing with events that occur in the playback of the primary content. The timeline may be displayed as part of a larger presentation of supplemental timeline content. As an addition or alternative to timelines, time-line related features and functionality may be displayed to the user in the form of the supplemental timeline content. Embodiments provide for the primary content timeline being based on metadata associated with the primary content. The primary content can include, for example, movie titles, television programming, video clips, live broadcasts, or other audio/video presentations. In an embodiment the primary content includes an AV stream. In another embodiment, the primary content can be stored on the user's device.

In variations, the supplemental timeline content can include time-based elements that display content and/or provide functionality, including the ability to receive user input and interaction. For example, interface elements may display product advertisements. In an embodiment the interface elements can provide a source of user interaction, to enable content and/or functionality displayed with the elements to be changed. Still further, interface elements may interact with one another, to enable, for example, new elements to replace prior elements, or to enable new additional elements. For example, in an embodiment the interface elements may be scrolled to display new metadata-based supplemental content. The meta-data based supplemental content can be pre-associated with the primary content.

Still further, some embodiments provide that the interface may display multiple timelines. For example, a secondary timeline may be displayed which illustrates the progression through the metadata as well as a timeline showing progression through the primary content. Furthermore, each timeline that is displayed may be synchronized with the playback of the primary media, so that events depicted in the timeline correspond to events that are depicted in the primary media. In such an embodiment the metadata timeline and primary media timeline may be synchronized, so that they are aligned in their display. This may be used to control, for example, updating the interface elements and primary content timeline as described below, so that updating the interface elements and timeline(s) is based on the progression of the primary content.

Within the presentation of a timeline, various indicators for primary content are present which indicate the presence of an item (e.g., commercial product, song, person) in the primary content at a particular time in the playback of the primary content. The timeline may include graphic markers or content that is based on the metadata, such as timing information that is indicative of when individual scenes or frames in the primary content occur, after playback of the primary content is initiated. For example, in an embodiment, metadata can identify an actor who appears in a particular scene in the primary content, and/or a song that is played during the scene, and/or a commercial object which appears in the primary content. The timeline may be displayed on the user interface in any appropriate location such as in order not to interfere with the user's enjoyment of the primary content.

Still further, embodiments enable one or more timelines to be displayed in any way to present a time axis in the navigation of the media. For example, the timeline may be displayed horizontally, vertically, or substantially circularly. In one or more embodiments, one or more images may be displayed which represent particular portions of primary content which appear in the primary content. The images may be displayed sequentially so that the images may be displayed in an order reflecting their order of appearance in the primary content. For example, a first displayed image may correspond to or be determined from a first portion of primary content, and a second displayed image may correspond to or be determined from a second portion of primary content. In another embodiment, the timeline may be displayed in the form of a strip or line. In another embodiment, the timeline may be displayed in a circular perspective.

The portions of primary content may, additionally or in the alternative, be represented by timeline elements displayed on the interface. The timeline elements include content that is based, or determined from corresponding portions (per timeline) of the primary content.

According to embodiments, the presentation of the timeline(s) can be updated based on either the natural progression of time, coinciding with playback of the primary content, or user-input that afters what aspect of the timeline is viewed independently of the primary content. In Step 104, an embodiment, user input is received on the supplemental timeline content, and the input forces one or more timelines displayed as part of the supplemental timeline content to fast-forward/reverse (or artificially progress or regress).

In Step 106 the supplemental timeline content is updated based on the artificial progression, which is identified from the user input. Specifically, one or more timelines can be updated to display content that reflects a relative instance of time in the playback of the primary content, except for the relative time is determined from user input, rather than the natural progress of the playback. For example, the timeline can be reflected in the form of one or more horizontal bar. If the portion of primary content is identified to be a song, the primary content timeline or any timeline elements could be updated and changed to show the appearances of the song in the media timeline. For example, the primary content timeline may be visually altered to show in which sections of the primary content the portion of primary content appears. In another embodiment portions of the timeline are re-colored to show the user where the song appears in the timeline.

Additionally in Step 106 a timeline element may be updated to reflect the portion of primary content used to update the primary content timeline. The source of the initial and changed images may be any appropriate sources. For example, the changed image data may be stored in the metadata of the media file. In another example, the changed image may be a generic image which is stored in the interface.

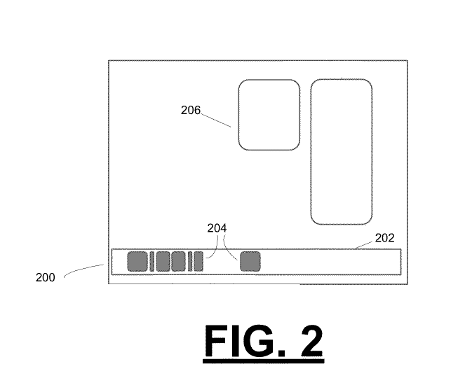

FIG. 2 illustrates an interface that includes supplemental dynamic timeline content, in accordance with an embodiment. In an embodiment, supplemental dynamic timeline content 200 is displayed separately from a display in which movie or primary content is provided. For example, the supplemental dynamic timeline content 200 can be displayed on a tablet device that a user operates in connection with a movie. Other mediums for the supplemental dynamic timeline content 200 include mobile devices, personal computers or laptops, or designated screen regions of the primary display. Still further, in variations, the supplemental dynamic timeline content 200 can overlap with the primary content.

In an embodiment, the supplemental dynamic timeline content 200 includes a media timeline 202, which displays information that is indicative of the progression of the primary content. The media timeline 202 can display features, including timeline elements 204 which represent or coincide with individual events in the primary content that are associated with a certain segment of time in the primary content (e.g., media file). In this way, the timeline elements 204 can be provided in the timeline 202 to coincide with the occurrence of events that occur in the primary content (e.g., movie plot events). In an embodiment, timeline elements 204 may be differently sized in order to reflect the length of the time interval that the elements represent.

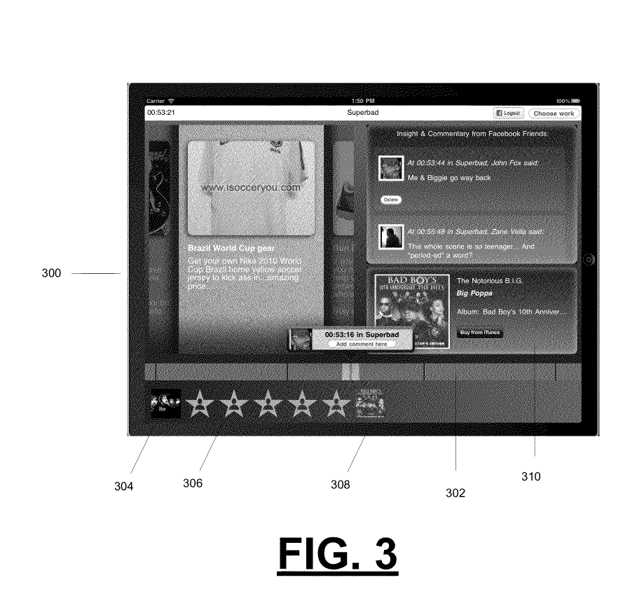

The supplemental dynamic timeline content 200 may also include user interface elements 206, which can be implemented for various different functionality or roles. For example, as shown with an embodiment of FIG. 3 and elsewhere, the user interface elements can be used to display music titles, album art, artists, commercial products, and social network feeds or commentary in connection with the display of the primary content at a particular segment of time. Various other forms of content can also be displayed using the elements 206, such as actors/actress information or biography, related content, advertisement etc.

While FIG. 2 illustrates a particular arrangement for the relative placement of the media timeline 202 and the elements 206, various alternatives may be provided, including placing the media timeline 202 above elements 206, placing the media timeline 202 centrally, or locating the media timeline 202 vertically.

Embodiments provide for the interface element allowing the user to interact with the media as described here. A user interaction for example may involve the user touching or manipulating the input mechanisms (e.g. touch-screen) of a device corresponding to the secondary presentation to indicate a selection input.

In an embodiment, the dynamic timeline content 200 is time-based, and synchronized with the primary content timeline, so that the dynamic timeline content 200 coincide in time with the events that occur in the primary content. According to embodiments, various aspects of the supplemental dynamic timeline content 200 are updated based on the (i) the progression of time, and (ii) user input that forces or alters the natural progression of the timeline, so as to affect some or all of the supplemental dynamic timeline content 200. At any given instance, the media timeline 202 reflects a current instance, which can be based on natural progression (e.g., synced with movie title) or forced by user input. The media timeline 202 can also reflect the forward and backward views of the timeline based on the current position of the movie title (as reflected in the movie title). The elements 206 may be used to display certain content, or provide certain functionality, that is based on the current state of time reflected in the media timeline 202. The current instance of the timeline can be altered by the user, and the media timeline 202 (e.g., forward and backward views), as well as the elements 206 can be altered based on what is the current instance of the timeline.

As further described, the user input can be provided to cause the aspects of the dynamic timeline content 200 to vary from what would otherwise be displayed due to the natural progression of time. For example, user interface elements 206 can be fast-forwarded (or re-winded) in the timeline to display supplemental content located at a previous or later point in the timeline. The visual elements of the interface appear and disappear (are updated) as the timeline 202 of the media is traversed.

FIG. 3 illustrates an example of an interface that includes supplemental dynamic timeline content, according to an embodiment. Progression through supplemental media content 300 is indicated by supplemental dynamic timeline 302. In an embodiment the timeline is represented as a horizontal bar indicative of the primary content being rendered. Supplemental dynamic media timeline elements 304, 306 and 308 include both blank supplemental dynamic media timeline elements 306 and filled images such as filled timeline elements 304 and 308. The blank supplemental dynamic media timeline elements 306 are not yet associated with supplemental media content 300. As supplemental media content is displayed, the blank supplemental dynamic media timeline elements may become associated with the supplemental media content and their icon may be replaced. For example, timeline element 308 is associated with the media content “Big Poppa” and displays an image of the corresponding music album cover art. Timeline element 304 in FIG. 3 similarly displays album art.

In an embodiment a visual indicia such as a line is generated on the horizontal timeline when a filled timeline element is selected. The user may then navigate using the generated indicia to the indicated section of the media and view or experience the desired timeline element.

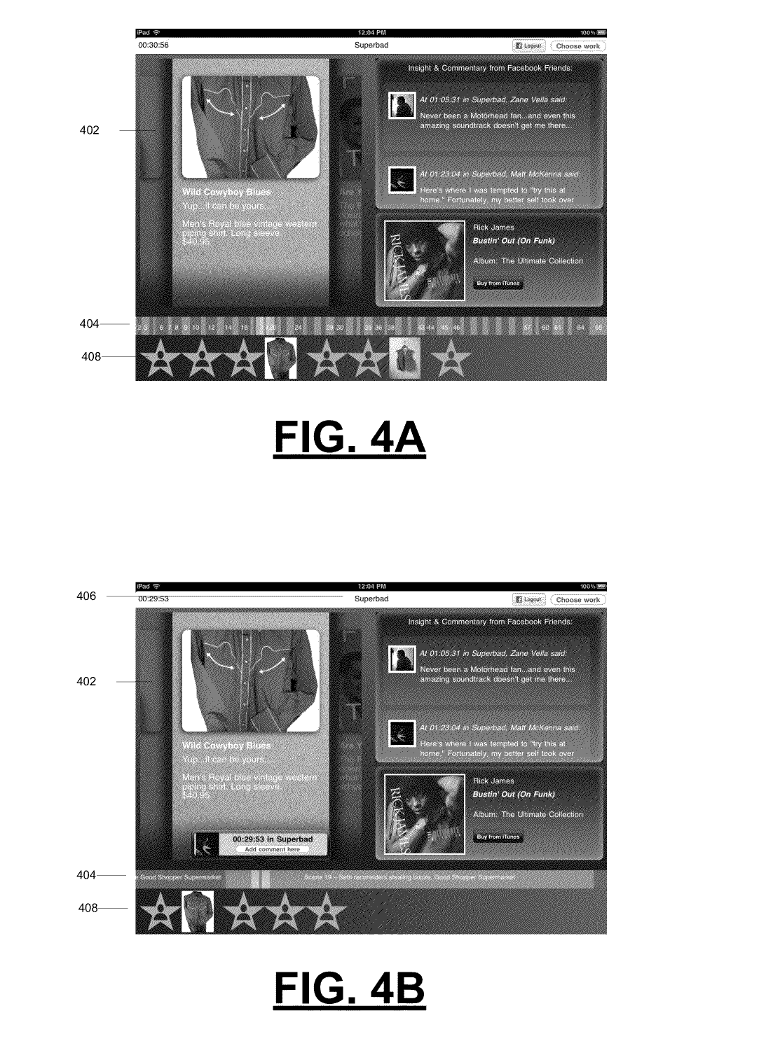

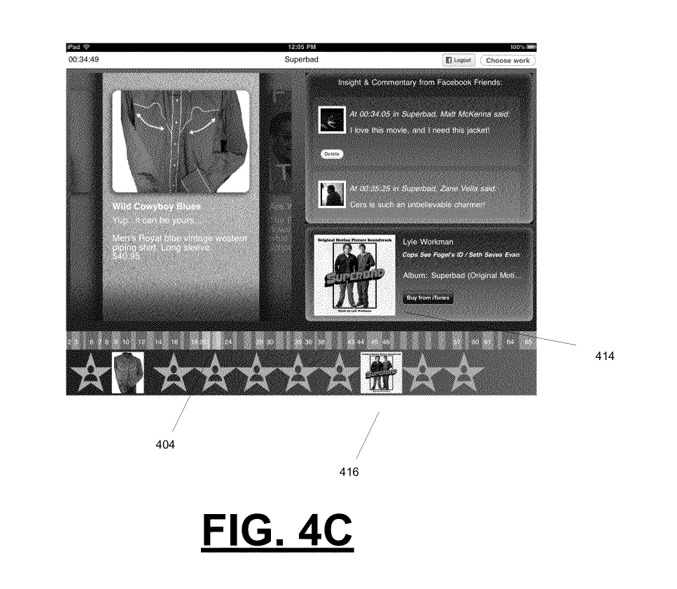

FIG. 4A-4C illustrate interfaces for displaying dynamic timeline content, according to one or more embodiments. The interfaces displayed in FIG. 4A through FIG. 4C illustrate supplemental dynamic timeline content 402, coinciding with playback of primary content (e.g., the movie “Superbad”, not shown) which can be displayed to the user, on, for example, a primary device (e.g. television). The supplemental dynamic timeline content 400 includes, for example, a content portion 402 that displays supplemental in, for example, user-interface elements (e.g., see FIG. 2). The supplemental content can take various forms, including content displaying commercial objects, information about actors/actresses, songs, social network content etc. The media timeline 404 represents the timeline associated with the primary content and the supplemental content. In an embodiment, user input can force variation in the current instance of the timeline, independent of the playback of the primary content. When the current instance of the timeline 404 is altered by input, content provided in the content portion 402 may be updated or altered to reflect the change in the timeline, independent of the timing in the playback of the primary content. For example, the content portion 402 (displaying a “Wild Cowboy Blue” shirt) can be identified because the user selects a particular instance of time from the media timeline that coincides with the occurrence of the shirt in the playback of the primary content (assuming natural playback progression).

According to an embodiment, the supplemental dynamic media timeline 404 is updated to show at which time(s) the shirt appears in the movie. The portions of the timeline 404 are updated to reflect where the shirt appears in the movie.

According to some embodiments, the timeline 404 can also include a separate iconic or graphic time-based feature set that displays objects based on the current instance of the timeline 404. For example, if user input selects to move the current instance of the timeline 404 forward, one or more additional objects may be provided in the time-based feature set to reflect the current instance, as determined from user input.

FIG. 4B illustrates a “zoomed in” embodiment of FIG. 4A, wherein the timeline 404 and timeline elements 408 are updated. The timeline now indicates “Scene 19”. The timeline elements 408 are also updated.

FIG. 4C illustrates an embodiment in which the user has selected the supplemental media content “Lyle Workman” located in the user interface element 414. In response to the selection, blank supplemental dynamic media timeline element 416 is replaced by a “Superbad” music album cover and the timeline 404 is updated for when to show when that content appears in the primary content. As shown, user selection can occur independently of playback of the primary content (e.g., movie title for “Superbad”). Thus, content associated with the time-based supplemental content (e.g., with regard to user interface elements or the timeline) can be updated to reflect changes in the current instance of one or more timelines provided with the supplemental content.

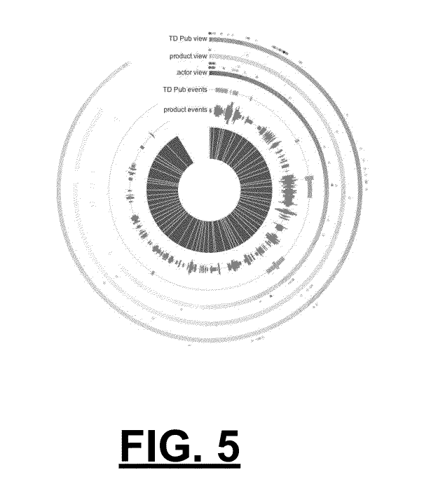

FIG. 5 illustrates an alternative interface for displaying timeline content and functionality related to the display of supplemental content using metadata, according to an embodiment. In FIG. 5, timeline content, including the events depicted in the timeline, are dynamically mapped in a circular fashion. The events are selectable along corresponding concentric circles. In such an embodiment, the user may simultaneously view the elements of all of the events.

Computer System

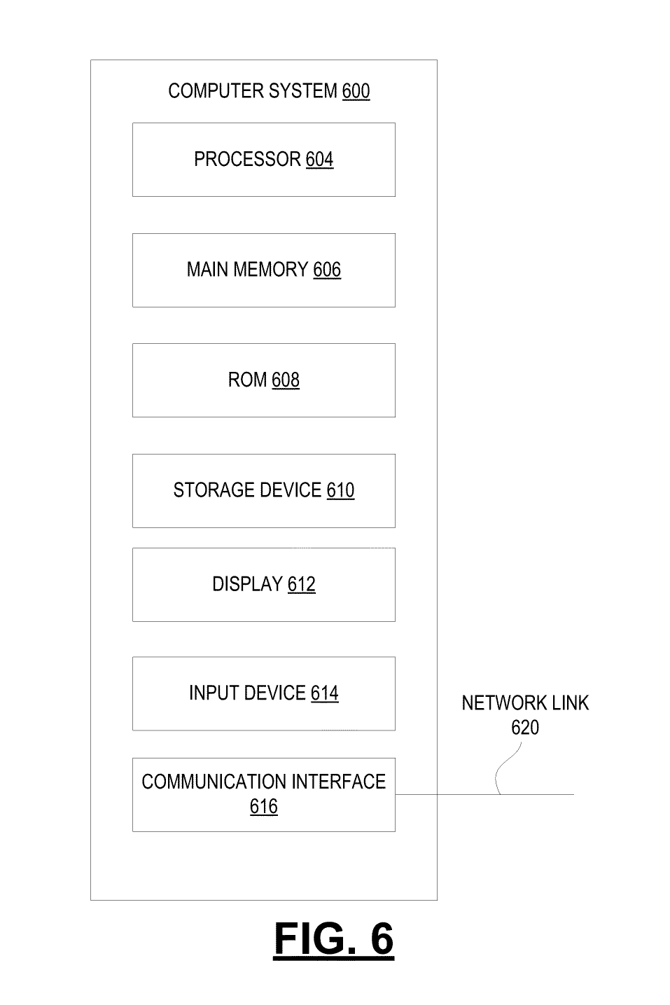

FIG. 6 is a block diagram that illustrates a computer system upon which embodiments described herein may be implemented. For example, embodiments such as described with FIG. 1 through FIG. 5 may be implemented using a computer system such as described by FIG. 6.

In an embodiment, computer system 600 includes processor 604, main memory 606, ROM 608, storage device 610, and communication interface 616. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read-only memory (ROM) 608 or other static storage device for storing static information and instructions for processor 604. A storage device 610, such as a magnetic disk or optical disk, is provided for storing information and instructions. The communication interface 616 may enable the computer system 600 to communicate with one or more networks through use of the network link 620.

Computer system 600 can include display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for dynamically updating a timeline, the method being implemented by one or more processors and comprising:
displaying a first timeline associated with playback of the primary content;
altering a current instance of the first timeline based on user input; and
updating a second timeline that includes at least one content element determined from the playback of the primary content, based on the current instance.

2. The method of claim 1, wherein altering a current instance of the first timeline includes receiving a user input corresponding to a new time location in the playback of the primary content.

3. The method of claim 1, wherein updating the second timeline includes changing the at least one content element based on a new instance of the playback.

4. The method of claim 1, wherein the at least one content element correspond to metadata associated with the playback.

5. The method of claim 1, further comprising displaying at least one timeline element on the first timeline, each of the at least one time element corresponding to an event in the primary content.

6. A non-transitory computer readable storage medium storing instructions for dynamically updating a first timeline, the instructions when executed by a processor cause the processor to:
display a first timeline associated with playback of the primary content;
after a current instance of the timeline based on user input; and
update a second timeline that includes content elements determined from the playback of the primary content, based on the current instance.

7. The storage medium of claim 6, wherein altering a current instance of the first timeline includes receiving a user input corresponding to a new time location in the playback of the primary content.

8. The storage medium of claim 6, wherein updating the second timeline includes changing the at least one content element based on a new instance of the playback.

9. The storage medium of claim 6, wherein the at least one content element correspond to metadata associated with the playback.

10. The storage medium of claim 6, further comprising displaying at least one timeline element on the first timeline, each of the at least one time element corresponding to an event in the primary content.

11. A computing device, comprising:
a processor;
a screen; and
a non-transitory computer-readable storage medium encoded with executable computer program code for executing by the processor to display a notification on the screen of the mobile computing device, the computer program code comprising program code for:
displaying a first timeline associated with playback of the primary content;
altering a current instance of the first timeline based on user input; and
updating a second timeline that includes content elements determined from the playback of the primary content, based on the current instance.

12. The computing device of claim 11, wherein altering a current instance of the first timeline includes receiving a user input corresponding to a new time location in the playback of the primary content.

13. The computing device of claim 11, wherein updating the second timeline includes changing the at least one content element based on a new instance of the playback.

14. The computing device of claim 11, wherein the at least one content element correspond to metadata associated with the playback.

15. The computing device of claim 11, further comprising displaying at least one timeline element on the first timeline, each of the at least one time element corresponding to an event in the primary content.
